(19) United States
(12) Patent Application Publication
(10) Pub. No.: US 2011/0040576 A1
(43) Pub. Date: Feb. 17, 2011

(54) CONVERTING ARBITRARY TEXT TO FORMAL MEDICAL CODE

(75) Inventors: Umesh Madan, Bellevue, WA (US); Eugene Lee, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/539,602

(22) Filed: Aug. 11, 2009

(51) Int. Cl. G06Q 50/00

(52) U.S. Cl. 705/3

(57) ABSTRACT

Medical records may be evaluated in order to assign condition codes to the records in a medical vocabulary. In one example, the medical vocabulary contains a list of codes (e.g., numeric codes) that correspond to specific conditions, where each code is associated with a concept description. Text from a medical record may be used to form a query, and the query may be evaluated against the concept descriptions to determine which code(s) match the query. A code may be selected based on how well the description associated with that code matches the query. The process of converting text from medical records into queries, and then comparing the query to concept descriptions in a medical vocabulary, may be used to automate the process of assigning formal medical codes to arbitrary text records.

### BACKGROUND

There are formal medical vocabularies that may be used to describe medical conditions. For example, the Systematized Nomenclature of Medicine—Clinical Terms (“SNOMED CT”) and the Mayo Clinic vocabulary are examples of two formal medical vocabularies. These vocabularies represent precise taxonomies of medical conditions.

Medical records, however, are often written in free form text that sometimes corresponds with a formal vocabulary, and that sometimes does not. For example, a formal vocabulary might define specific phrases, such as “pain, left ear” and “pain, left ear, severe”, each of which defines a specific condition with a specific medical significance, and each of which has an assigned numeric code within some medical vocabulary. A medical record might contain the exact text or numeric code associated with a condition, or it might contain some free-form text such as “pains in the left ear.” One task that arises in the management of medical records is to evaluate arbitrary text and determine which condition, in some target vocabulary, corresponds to the text.

### SUMMARY

Arbitrary input text may be evaluated to determine which code in a target medical vocabulary corresponds to the input text. The input text may be a free form description, a description in the target vocabulary, a code in the target vocabulary, or a description or code in some medical vocabulary other than the target vocabulary. A system evaluates the input text and determines which code in the target vocabulary corresponds to the input text.

In order to determine which code in the target vocabulary corresponds to the input text, the input text is compared with the terms in the target vocabulary. In order to perform this comparison, the input text may be normalized. For example, punctuation and stop words may be removed, spelling errors may be corrected, and the stems of the remaining words may be expanded into various forms. The resulting set of words may be used to form a query. The query may be compared with the display text associated with the various codes in a vocabulary, in order to determine which code matches the query (where the “display text” may be the text string associated with a particular condition code).

Determining a match between a code and a query may be performed in a variety of ways. For example, the comparison process may look for an exact match between the query and a particular code's display text. Or, the various codes may be scored against the query for relevance, with higher scores being assigned to codes whose associated display text more closely matches the query. Or, a combination of these techniques may be used.

In addition to matching a query against the display text, various other techniques may be performed. For example, input text may be analyzed to determine whether it already contains a particular condition code, in which case the text may be determined to correspond to that condition code. Another example technique that may be performed is to analyze the input text for the presence of acronyms, so that acronyms may be treated differently from other text in the input string. Moreover, conditions may have various synonyms, and the input text may be evaluated against a list of synonyms to determine whether it contains synonyms for a particular condition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system that may be used to assign a code to a textual description of a medical condition.

FIG. 2 is a block diagram of some example descriptions, and an example medical vocabulary against which the descriptions may be compared.

FIG. 3 is a flow diagram of an example process of building a query.

FIG. 4 is a block diagram of various example query processing modes.

FIG. 5 is a block diagram of an example acronym detector, and of an example process that the acronym detector may perform.

FIG. 6 is a flow diagram of an example process that may be used to assign codes to text.

FIG. 7 is a block diagram of example components that may be used in connection with implementations of the subject matter described herein.

### DETAILED DESCRIPTION

Formal medical vocabularies, such as SNOMED CT and the Mayo Clinic vocabulary, may be used to describe medical conditions in standard ways. These standard descriptions of medical conditions provide a certain level of precision expected by the medical profession. A medical vocabulary typically has a textual description of a condition (which may be referred to as the “display text” or “concept description”), and a code (e.g., a numeric code) associated with that condition. A recognized medical condition generally corresponds to a code in a medical vocabulary. For example, the SNOMED CT vocabulary defines the condition “Diabetes mellitus type 2”, and associates the numeric code “44054006” with that condition.

While medical vocabularies provide a precise, standard way to describe medical conditions, medical records may, or may not, describe conditions using the precise coding scheme of medical vocabularies. For example, a medical record might state that the patient has “adult-onset diabetes”, or might just say that the patient has “diabetes.” There may be reason to convert this description into a formal medical vocabulary.

Assigning formal codes to information contained in medical records is generally performed by people. While the process of assigning formal codes to medical data could be made more efficient through automation, the process of assigning the codes is complex (and is generally performed by professional medical coders), and thus automation of this task is difficult.

The subject matter herein provides a way to automate, or to partially automate, the task of determining what code in a target medical vocabulary corresponds to an arbitrary text record. The text record could be free-form text, or could be a code in the target vocabulary, or could be a code in a vocabulary other than the target vocabulary. Techniques described herein may be used to evaluate the text, and to identify the code in the target vocabulary to which the text corresponds.

Input text may be evaluated to determine whether the text already contains a code. If the text already contains a code, then the text may be found to correspond to that code without further analysis. If the input text does not contain a code, then a query may be built from the text, and the query may be matched against the target vocabulary in order to determine what code in the target vocabulary closely corresponds to the text.

In order to turn the input text into a query, the text may be normalized by removing punctuation and some pre-defined set of stop words. Additionally, spelling errors may be corrected, word stems may be expanded into their various forms, and known synonyms may be added to the set of words. For example, text that contains the phrase “pains in the left-ear” may be normalized by removing punctuation (the hyphen) and stopwords (the words “in” and “the”), thereby resulting in the set of words “pains left ear”. This resulting set of words may be turned into a query, such as “pains AND left AND ear”. Since “pain” and “pains” are different forms of the same stem, the query may be expanded by replacing “pains” with a Boolean expression that represents both forms—e.g., “(pain OR pains) AND left AND ear”. If discomfort is a recognized medical synonym for pain, then the Boolean expression may be expanded further by adding this synonym to the OR expression—e.g., “(pain OR pains OR discomfort) AND left AND ear”. The foregoing example shows one way to construct a query from input text, although the query could be constructed in other ways (e.g., the query could be represented as a vector, which could then be compared with the vector representation of codes in the vocabulary by using vector comparison techniques).

Once a query has been constructed, the query may be compared to the text associated with the various terms in the target medical vocabulary. For each concept defined a medical vocabulary, the vocabulary generally has a code (e.g., a numeric code), and an associated sequence of words that may be referred to as the “display text” or “concept description.” The query may be compared to the display text in order to determine how well the query fits a given display text. In performing the comparison, various criteria may be used. For example, the comparison process may insist on an exact match between the AND-ed expressions in the query and the words associated with a code. Or, the comparison process may allow less than an exact match, and may rely on human input and/or relevancy rankings in order to determine how well the query matches a particular code. Or, the comparison process could use some combination of Boolean matching and relevancy rankings. Thus, if a medical vocabulary contains codes for three separate ear pain conditions, and if the display texts for these codes are “ear pain”, “ear pain, left” and “ear pain, left, severe”, the process of comparing the query to the codes may chose which of these textual descriptions (if any) represents the closest match to the query that was derived from the input text. Once a matching code has been found for the query, that code may be assigned to the medical record that contains the input text.

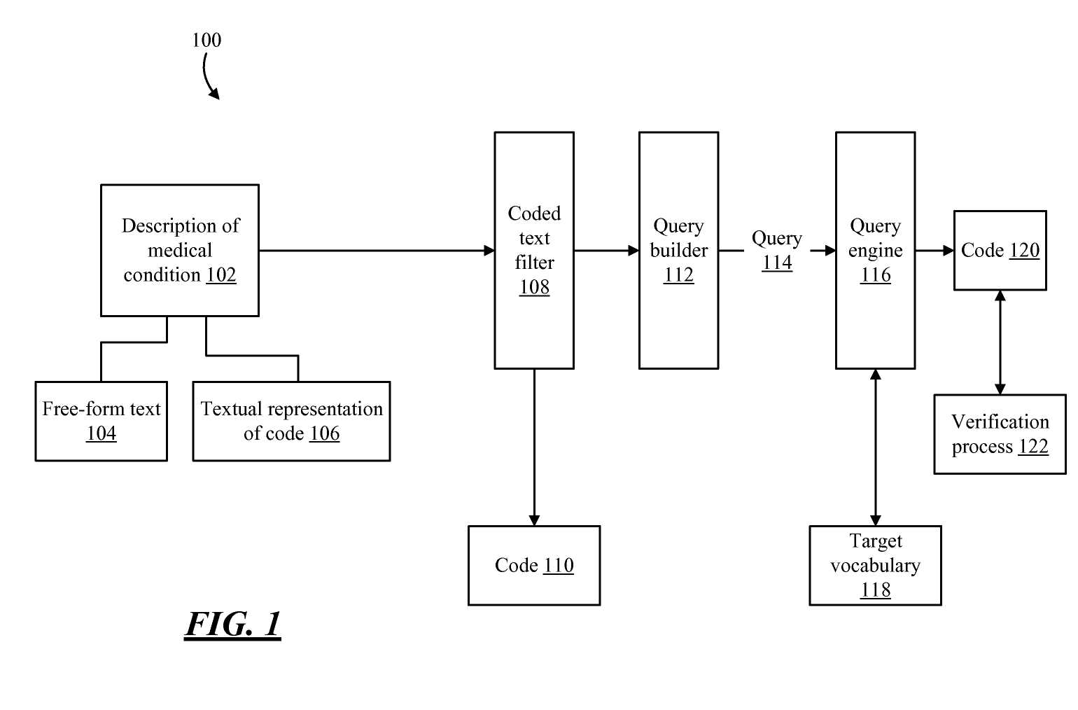

Turning now to the drawings, FIG. 1 shows an example system 100 that may be used to assign a code to a textual description of a medical condition.

System 100 takes, as input, a description 102 of a medical condition. Description 102 may, for example, describe a physical condition of a person, or may describe a physical procedure that has been performed on a person. Description 102 could take the form of free-form text 104, a textual representation of a code 106, or some other form. An example of free-form text 104 is “pain in the left ear”. If a medical vocabulary associates a code such as “12348” with the display text “severe right ear pain”, then the text “12348” would be an example of a textual representation of a code 106. The fact that description 102 could take various forms is due to the fact that medical information may be provided from a variety of sources, where some sources may choose to express information in a vocabulary's codes, and other sources may choose to express the information free-form. For example, some hospitals may provide the code for a medical diagnosis, and thus a text field in a medical record may simply contain the numeric code assigned by the hospital's personnel. On the other hand, some health-care providers may write a free-form description that is to be coded by other people. In still other situations, a health record may contain a patient's self-description of his or her medical condition (and the patient is unlikely to be familiar with a formal medical vocabulary and its codes). System 100 may be configured to handle some or all of these situations.

Description 102 may be provided to coded text filter 108, which determines whether description 102 has already been coded. If description 102 appears to contain a textual representation of a code 106, then coded text filter 108 may detect this fact. So, for example, if description 102 contains the text “44054006 mellitus diabetes type-2” (or some close variation of this text), then coded text filter 108 may detect the fact that description 102 is already coded. Thus, coded text filter 108 may cause system 100 to identify a particular code 110 that is associated with description 102 based on the fact that description 102 has been found to contain a code in the target vocabulary.

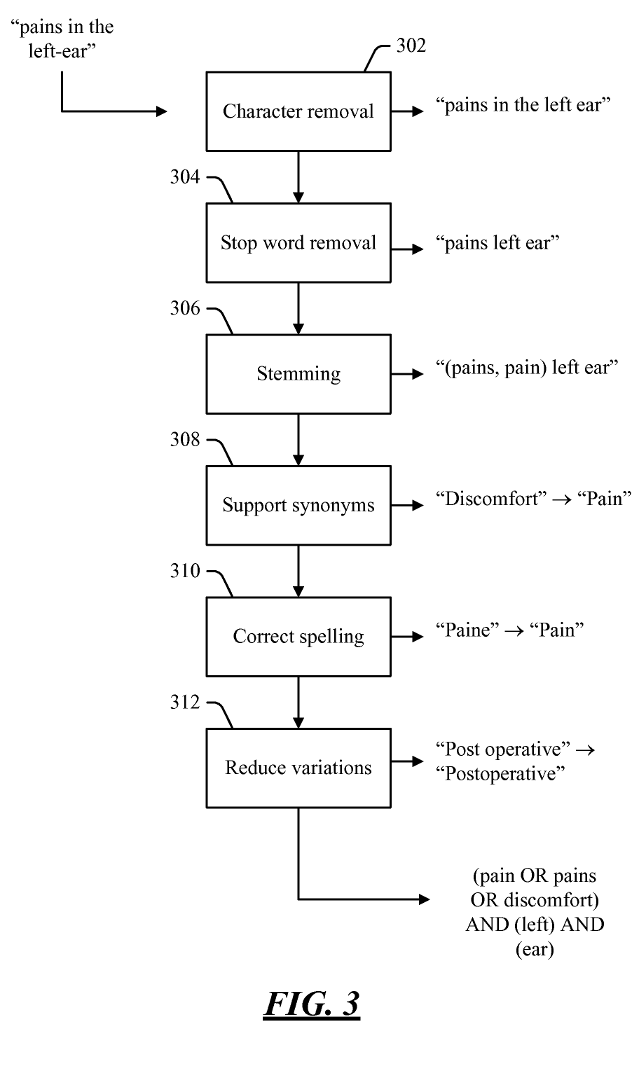

On the other hand, if coded text filter 108 does not find that description 102 contains a code, then description 102 may be passed to query builder 112. Query builder 112 creates a query based on the text contained in description 102. Query builder 112 may use various techniques for building the query. These techniques are more particularly described below in connection with FIG. 3.

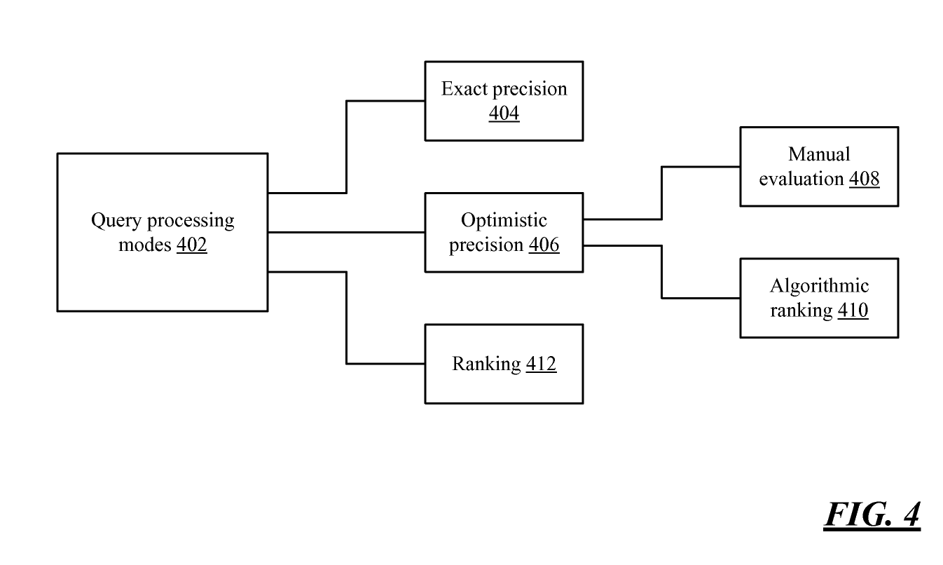

When query builder 112 has built a query 114, the query 114 may be provided to query engine 116, which compares the query 114 with target vocabulary 118. Query engine 116 may be based on a standard, off-the-shelf search technology (e.g., Apache Lucene), or could be based on any other search technology. Query engine 116 compares query 114 with the textual descriptions in target vocabulary 118, and determines whether there is a match between the query and some code in target vocabulary 118. (Target vocabulary 118 may contain descriptions of physical conditions of the human body and/or physical procedures or treatments that may be performed on the human body.) Query engine 116 may use various techniques to determine which (if any) codes in target vocabulary 118 fit query 114. Examples of these techniques are discussed below in connection with FIG. 4.

If query engine 116 determines that there is a match between query 114 and some term in target vocabulary 118, then query engine 116 generates a code 120. Code 120 may then be associated with the description 102 that was received as input by system 100. For example, if the input description is “adult-onset diabetes”, system 100 may determine that the code that corresponds to this condition is “44054006” (the SNOMED CT code for type-2 diabetes), so that code may be associated with the input description.

Some techniques for comparing query 114 with target vocabulary 118 may operate at a high level of reliability, where there is a very high probability that any code produced by these techniques is the correct code for the input. These techniques can operate without human verification. However, some techniques have a lower level of reliability. When such lower-reliability techniques are used, the code 120 that is chosen by query engine 116 may be subject to a verification process 122. Verification process 122 could take any form. In one example, verification process 122 involves a human's looking at the code chosen by query engine 116 so that the human can accept or reject the choice.

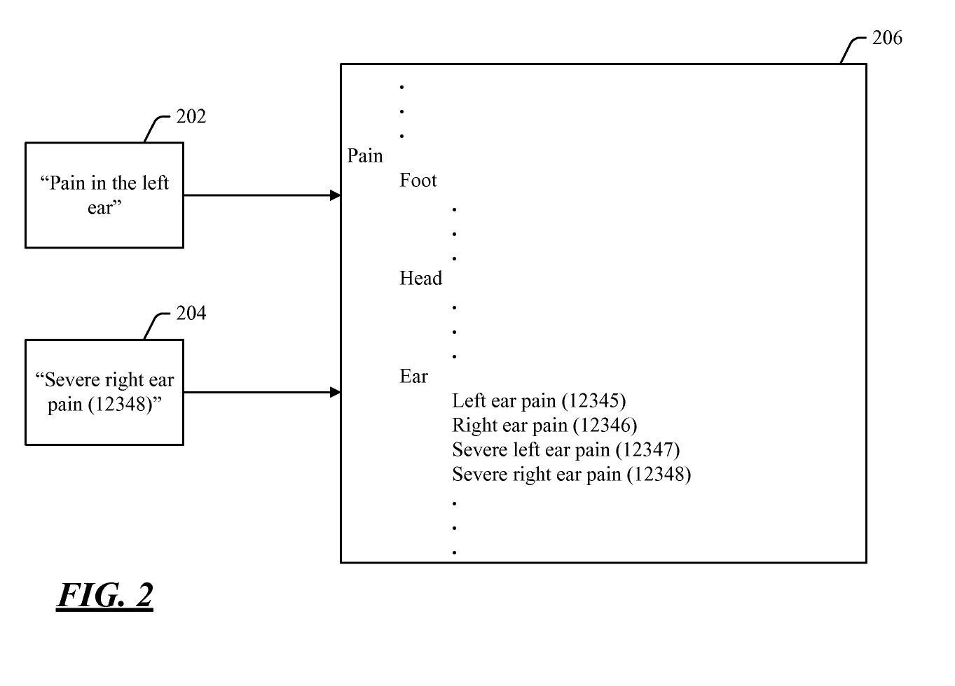

As noted above, textual descriptions may be free-form descriptions or coded descriptions. FIG. 2 shows examples of some descriptions, and a medical vocabulary against which the descriptions may be compared.

In the example of FIG. 2, description 202 comprises the text “pain in the left ear”, and description 204 comprises the text “severe right ear pain (12348)”. Vocabulary 206 represents a taxonomy of various human ailments, and comprises a list of descriptive terms and their associated codes. Thus, vocabulary 206 comprises a general category “pain”, and sub-categories for different parts of the body in which pain may be experienced (“foot”, “head”, “ear”, etc.). Additionally, a sub-category may have further sub-categories, indicating specific types of pain in specific parts of the body. Each such type of pain may have a different medical significance, and thus may have its own code in vocabulary 206. For example, under the sub-category of “ear”, there may be several different types of pain: “left ear pain”, “right ear pain”, “severe left ear pain”, “severe right ear pain”, and so on. The existence of these narrowly-defined categories represents a judgment (in the view of the vocabulary designers) that each of the different categories has a different medical significance. For example, “severe” ear pain may be considered a different medical problem from regular (non-severe) ear pain, in the sense that one level of pain might call for antibiotic treatment while the other might not. Moreover, there may be reason to keep records of which ear the pain occurred in, so that a history of problems in a specific area of the body can be established in the patient's medical history.

As a matter of terminology, the words associated with each code may be referred to as “display text,” or as a “concept description.” Thus, the display text associated with code “12345” is “left ear pain”, the display text associated with code “12346” is “severe left ear pain”, and so on.

The subject matter herein may be used to determine which code in a vocabulary corresponds to a textual description. Thus, a system (such as system 100, shown in FIG. 1) may be used to compare descriptions 202 and 204 with vocabulary 206, and to determine which code in vocabulary 206 corresponds to each of the descriptions. For example, a comparison of description 202 with vocabulary 206 may yield a determination that the code “12345” corresponds to that description. This conclusion is supported by the fact that the description (“pain in the left ear”) appears to contain all of the concepts (“left”, “ear”, and “pain”) that are in the display text associated with code “12345”. Description 202 is an example of a free-form description, since it does not already contain a code. On the other hand, description 204 is an example of a coded description, since it does already contain a code. Description 204 could thus be matched to code “12348” since its text contains that code, and also since the text of description 204 includes words that are consistent with the display text associated with code “12348”.

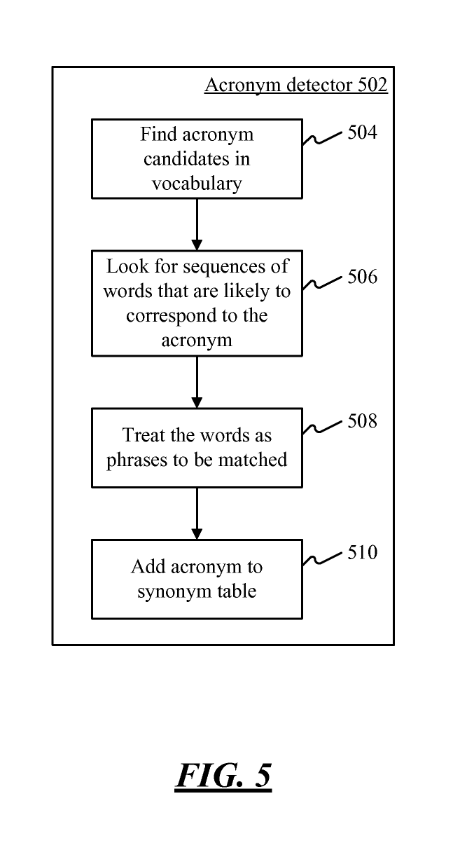

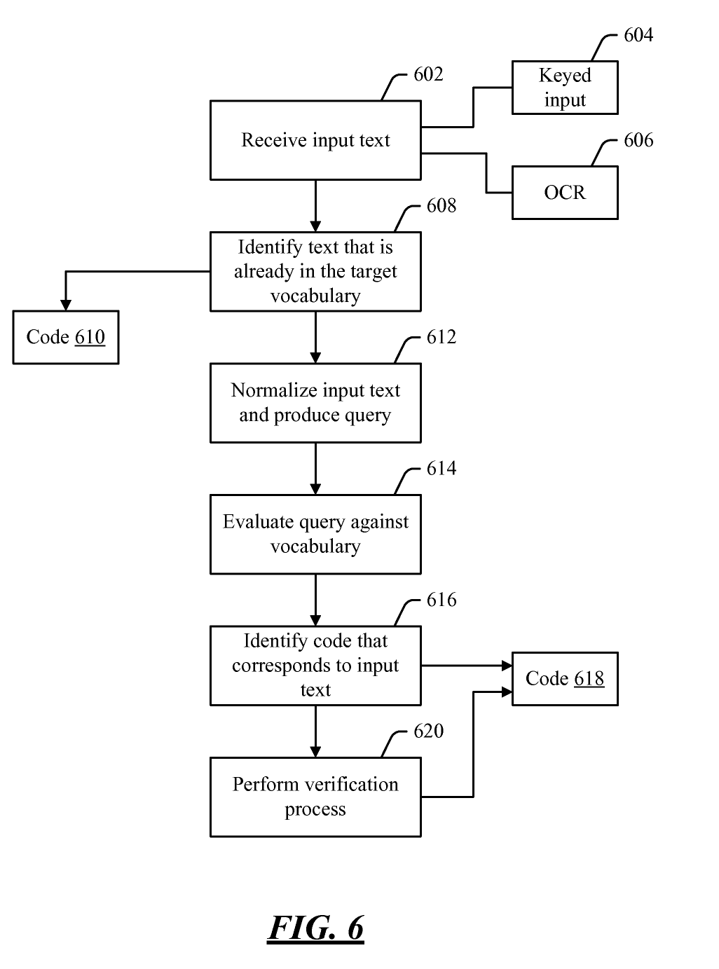

As noted above, an input description may be converted into a query, so that the query may be compared with a vocabulary. FIG. 3 shows an example process of building a query. Before turning to a description of FIG. 3, it is noted that the flow diagrams contained herein (both in FIG. 3 and in FIGS. 5-6) are described, by way of example, with reference to components shown in FIGS. 1-2, although these processes may be carried out in any system and are not limited to the scenarios shown in FIG. 1-2. Additionally, each of the flow diagrams in FIGS. 3, 5, and 6 shows an example in which stages of a process are carried out in a particular order, as indicated by the lines connecting the blocks, but the various stages shown in these diagrams can be performed in any order, or in any combination or sub-combination.

In the example of FIG. 3, it is assumed that the input description comprises the text “pains in the left-ear”. It will be understood that any input text could be used, but this particular text is used for purpose of illustration.

At 302, character removal is performed on the input text. For example, certain characters (e.g., punctuation or other symbols) may be removed. Thus, the phrase “pains in the left-ear” may be converted to “pains in the left ear”, due to removal of the hyphen character.

At 304, a pre-defined set of stop words may be removed from the input text. For example, small words such as “a,” “an,” “the,” “in,” “on,” etc., may be treated as stop words. Since these words are unlikely to act as significant discriminators when determining which medical code matches the input, they may be removed from the input when generating a query.

At 306, the stems of the input words may be identified, and these stems may be expanded into their various forms. For example, “pains” is a plural word, and its stem may be regarded as the singular form “pain.” Thus, this stem may be derived from the input word. The stem may then be expanded into its common forms, which include both the singular and plural form of the word pains. Thus, the term “pains” in the input may be treated, in the corresponding query, as if it were the two alternative words “pain” and “pains.” So, in effect, the input text is treated as if it had been “(pain,pains) left ear”.

At 308, support for synonyms is applied to the input string. For example, if “discomfort” is an accepted synonym for “pain,” then the input string may be treated as if it contained “discomfort” as an alterative form of the word “pain”.

At 310, spelling errors may be corrected. For example, if the input text had contained the word “paine,” and if this word were accepted as a common misspelling for the word “pain,” then the word “paine” could be converted to “pain,” so that the input text would be treated as if the correct spelling had been used.

At 312, variations on terms may be reduced to a specific form of the term. For example, if the input text contained a term such as “post operative,” this term might be reduced to the more common form “postoperative” (without the space). Through this reduction, the input text would be treated as if it had said “postoperative” instead of “post operative”—similarly to the way that spelling errors are corrected at 310.

As a result of the process in FIG. 3, the input text “pains in the left-ear” may be converted to a query such as “(pain OR pains OR discomfort) AND left AND ear”. This query may be compared to a medical vocabulary using one or more techniques, such as those discussed below in connection with FIG. 4.

In the above example, the query that is constructed is a Boolean query, which may be matched against the various codes' display texts using Boolean matching techniques. However, a Boolean query is merely one example of a query. In another example, the query is a vector, which may be compared with vector representations of the codes' display texts (e.g., using comparison techniques such as cosine similarity). If a vector query is used, techniques such as those described above may be used in constructing the vector (e.g., removal of punctuation and stop words, spelling correction, synonym expansion, etc.).

FIG. 4 shows various examples of query processing modes 402 that may be used to compare a query with a vocabulary.

One example of a query processing mode is an exact precision mode 404. In exact precision mode 404, an exact match between the query and a code in the vocabulary is found only when there is a term-for-term match between the words in the display text of a code and the words in the input text (after adjusting the input text by removing characters and stop words, expanding stems and synonyms, correcting spelling errors, etc.). For example, if the input text is “pains in the left-ear”, then—using the process described above in connection with FIG. 3—the query built from this text might be “(pain OR pains OR discomfort) AND (left) AND (ear)”. This query removes some stop words (“in” and “the”) and also allows some words that do not appear in the original text (i.e., it allows “pain” and “discomfort”, as potential substitutes for “pains”). However, the query contains one AND-ed expression for every non-stop-word. When processing this query in exact precision mode, a match between a query and a code is found only if there the display text for the code contains a word matching every AND-ed expression, and vice versa. So, for example, the above query would match a code whose display text is “pain left ear” or “left ear pain” or “left ear discomfort”. However, the query would not match a code whose display text is “ear pain” (because this display text has no word that matches “left”). Also, the query would not match a code whose display text is “severe left ear pain”, because the display text for that code contains the word “severe”, which does not match any expression in the query.

Exact precision mode 404 may provide a very high level of confidence that a piece of input text has been coded correctly. For example, since “severe ear pain” may have a different medical significance from “ear pain”, exact precision mode 404 avoids coding the phrases “pains in the left ear” as if it was “severe ear pain”, since the query lacks the term “severe.” In this example, there happens to be a code (in the example vocabulary of FIG. 2) whose display text does match the query (i.e., “left ear pain (12345)”). However, the price of achieving this high level of confidence is that insisting on an exact match between the AND-ed expressions in the query and the display text may leave several input records uncoded, since there might not be any code whose display text exactly matches the query formed from a given piece of input text. Thus, other modes of query processing may be used.

Another example of a query processing mode is optimistic precision mode 406. In optimistic precision mode, the query is compared to display text strings, but the query is allowed to match the display text even if there are excess terms in the display text that do not appear among the AND-ed expressions of the query. For example, the above example query (i.e., “(pain OR pains OR discomfort) AND left AND ear”) would match the display text “left ear pain” and “severe left ear pain”, since both display texts include all of the AND-ed expressions in the query. The display text “left ear pain” might be a more relevant match than “severe left ear pain” since latter display text contains a superfluous word (“severe”) while the former display text does not. However, the processing of the query might identify both matches, and then rely on an additional process to disambiguate the matches. This additional process could take the form of manual evaluation 408 and/or algorithmic ranking 410. With manual evaluation 408, the possible matches could be presented to a person. For example, the person might be shown codes in a list, along with their respective display texts and the original input text, and could be asked to select the code that constitutes the true match. It is noted that in optimistic precision mode (as well as in the other modes described herein), a form of prefix matching could be performed—i.e., if a particular term in the query does not find a match in a display text, the display text could be evaluated to determine whether a query term is a prefix of a term that is contained in the display text. (If a term in a display has a prefix that matches a query term, rather than matching the query term in its entirety, then the relevancy score of that display text could be lowered relative to what the score would have been if the display text term had exactly matched the query term.)

With algorithmic ranking 410, a relevance score could be assigned to each match. Techniques for scoring query matches are generally known in the field of searching, and any of these could be applied. For example, vectors can be created that represent the query terms and the display text terms, respectively, and these vectors can be compared for similarity. Cosine similarity is an example of a technique that may be used to make the comparison. Then, display texts whose vectors are more similar to the query vector can be given higher relevancy scores than display texts whose vectors are less similar to the query vector. A code that matches the input text could be chosen based on these relevancy scores.

Another example of a query processing mode is to rely mainly on ranking 412 when selecting the appropriate code for a piece of input text. For example, instead of constructing the query by joining expressions with the AND operator, all of the terms in the display text could be OR-ed together in a query. The resulting query is less restrictive than a query that uses AND-ed expressions and would thus match a larger number of display texts. However, the different display texts could be scored based on how relevant they are to the query, and an appropriate code could be chosen based on how well relevant that code's display text is to the query. (E.g., the display text with the highest relevancy score could be chosen.) Thus, in the above example in which the input text is “pains in the left ear”, the query constructed from this text (using the various techniques described above) might be “(pain OR pains OR discomfort) OR (left) OR (ear)”. This query would match various texts such as “ear”, “ear pain”, “left ear pain”, “severe left ear pain”, “left inner ear pain”, “left foot pain”, “right foot pain”, etc. However, these different matches could be scored for relevance, and an appropriate scoring algorithm might find that “left ear pain” is the closest match. Or, as another example, the query and display texts could be represented as vectors, and vector comparison techniques (e.g., cosine similarity) could be used to compare the vectors. Particular codes could then be ranked based on the distance between the vectors.

In one example, a code may be chosen solely based on the relevance scores of various codes (i.e., the scores indicating how relevant a particular code's display text is to the query that has been constructed from the input text). However, using relevance scores to rank codes may also be combined with other techniques. For example, in the exact match technique described above, relevance scores could be assigned to particular matches based on how similar the matching display text is to the original input. For example, if the display text matches the original input character-for-character, then that display text could receive a relatively high relevance score. However, as noted above, an exact-match query may include stem expansions, synonyms, spelling corrections, etc.; if a particular display text matches the query only because of stemming, synonyms, spelling corrections, etc.—rather than matching the original input text—then the display text could be given a relatively lower relevance score than a true word-for-word match would receive. Moreover, various forms of boosting could be applied—e.g., the initial relevance score assigned to a code could be increased if specific sub-expressions of the query match portions of the display text. Thus, relevance scoring may be combined with Boolean matching techniques to assess which code represents the closest match to a give input. (Or, as noted above, some techniques, such as vector comparison, may rely on relevance rankings and may entirely avoid performing Boolean matches.)

FIG. 4 shows some examples of query processing modes. However, any appropriate query processing mode could be used with the subject matter herein.

One issue that arises when comparing input text with the display text of codes is that the display text may contain acronyms. For example, the disease Amyotrophic Lateral Sclerosis is often known by the acronym “ALS”. Thus, in a medical vocabulary, the display text associated with the code for this condition might read “ALS—Amyotrophic lateral sclerosis”. A system could be configured to match an input text to this condition, regardless of whether the input text uses the full name of the disease, the acronym for the disease, or both. Thus, the subject matter herein may provide support for acronyms in the names of conditions.

FIG. 5 shows an example acronym detector 502, and an example process of detecting acronyms that may be performed by the acronym detector. One way to detect acronyms is to consider words that contain all capital letters to be acronym candidates, and then to verify that the number of other words in the display text equals the number of letters in the acronym candidate.

Thus, acronym detector 502 may implement the following example process. At 504, acronym candidates may be detected in vocabularies. As noted above, one way to identify acronym candidates is to look for words that contain all capital letters—e.g., “ALS” might be considered an acronym candidate. At 506, when an acronym candidate is detected in a particular display text, acronym detector 502 may look for sequences of words in that display text that are likely to correspond to the acronym. As noted above, one way identify a sequence of words that is likely to correspond to the acronym is to determine whether the number of words that remain in the display text (i.e., the number of words in the display text, not counting the acronym candidate itself) is equal to the number of letters in the acronym candidate. Additionally, the first letters of these words might be compared with the letters of the acronym candidate to determine whether the acronym matches the first letters of the words.

At 508, if a display text is found to contain an acronym (or a likely acronym) based on the foregoing procedure, then the words in the display text (other than the acronym candidate) may be treated as the set of words to be matched against input text. For example, if the display text for a given code is “ALS—Amyotrophic lateral sclerosis”, then the words “Amyotrophic lateral sclerosis” may be treated as the relevant set of words to be matched, and the acronym itself (“ALS”) may be ignored. Thus, in an exact precision query processing mode (described above in connection with FIG. 4), an input text of “amyotrophic lateral sclerosis” would match the display text. Although the input text does not contain one of the “words” in the display text (i.e., the input text does not contain the word “ALS”), this fact could be disregarded by the exact precision query processing mode, since ALS would have been detected as being an acronym rather than being part of the formal name.

Once the acronyms have been detected, at 510 the acronyms may be added to a synonym table. Thus, in the above example, a table may be created that includes an entry equating the string “ALS” with the disease name “Amyotrophic lateral sclerosis.” As noted above, terms may have synonyms, and a query can be construed that expands a term of input text with its various synonyms—e.g., in the above example, “discomfort” was treated as a synonym for “pain”, so a query for an input text containing the word “pain” could list discomfort as an alternative term. In a similar fashion, “ALS” could be regarded as a synonym for “amyotrophic lateral sclerosis”, so if the input text contains the string “ALS”, the query that is built from this input text might contain the term “(ALS OR (amyotrophic AND lateral AND sclerosis)” to reflect the fact that “amyotrophic lateral sclerosis” and its acronym are synonyms of each other.

FIG. 6 shows an example process that may be used to assign codes to text, using some or all of the techniques described above.

At 602, input text may be received. The “pains in the left-ear” example described above is an example of an input text. This text may be received as part of a medical record. For example, a set of medical records to be coded could be provided as input, and techniques described herein could be used to assign codes to the medical records. The input text may be obtained in a variety of ways. In one example, a medical record takes the form of text that has been keyed in as input (block 604). In another example, the text has been extracted from some other form—e.g., Optical Character Recognition (OCR) performed on handwritten text (block 606). As another example, text might be recovered from audio (e.g., a recording of a doctor's spoken notes) using speech recognition technology. The text to be used as input could be obtained in any manner.

At 608, text that has already been coded in the target vocabulary is identified. That is, if analysis of the input text shows that it contains a code and/or a display text that is a condition listed in the target vocabulary, then a code 610 may be assigned to that text, possibly without any further analysis. If the input text does not match a code and/or display text in the target vocabulary, then the process continues to 612.

At 612, the input text may be normalized, and a query may be produced. For example, query normalization procedures (e.g., removal of punctuation or certain other characters, removal of stop words, expansion of word stems, etc.) may be performed on the input text. Moreover, the query may be constructed from the remaining words. The process of constructing the query may involve expanding synonyms, correcting spelling errors, etc. The construction of the query may also take into account the particular query processing mode. For example, in the previous discussion of FIG. 4, it is noted that in some query processing mode (e.g., exact precision and optimistic precision) top level query expressions are connected by the Boolean AND operator, while in other query processing modes (e.g., a mode that relies on relevancy ranking to identify the closest match) top level query expressions are connected by the Boolean OR operator. Moreover, at noted above, some query processing modes may use vector comparison instead of Boolean queries.

At 614, the query is evaluated against the target vocabulary. For example, the query may be compared to the display text associated with each code, in order to determine which display text(s) match the query.

At 616, a code 618 is identified that corresponds to the input text. In some cases, comparison of the query with the vocabulary yields only one match, in which case the single code that is found to be a match is the code that is identified at 616. Using the exact precision query processing mode is likely (although not guaranteed) to yield no more than one match. On the other hand, with some query processing modes comparison of the query with the vocabulary yields plural matches. For example, a comparison scheme that relies mainly or partially on relevancy ranking, may generate several matches. In this case, the particular code that is the closest match to the query may be selected, and that code may be identified at 616.

At 620, a verification process may be performed on the code that has been identified at 616. For example, with optimistic precision, the relevancy score of a match may be evaluated to determine whether it exceeds some threshold (where the code might be assigned based on the match if the relevancy of the match exceeds the threshold). Or, when plural matches are found, the code could be assigned based on the match with the highest score. Or, verification could be performed by a person. For example, if a single matching code is found the person could verify the correctness of that code; and if plural matches are found the person could select the correct match from among the plural matching codes.

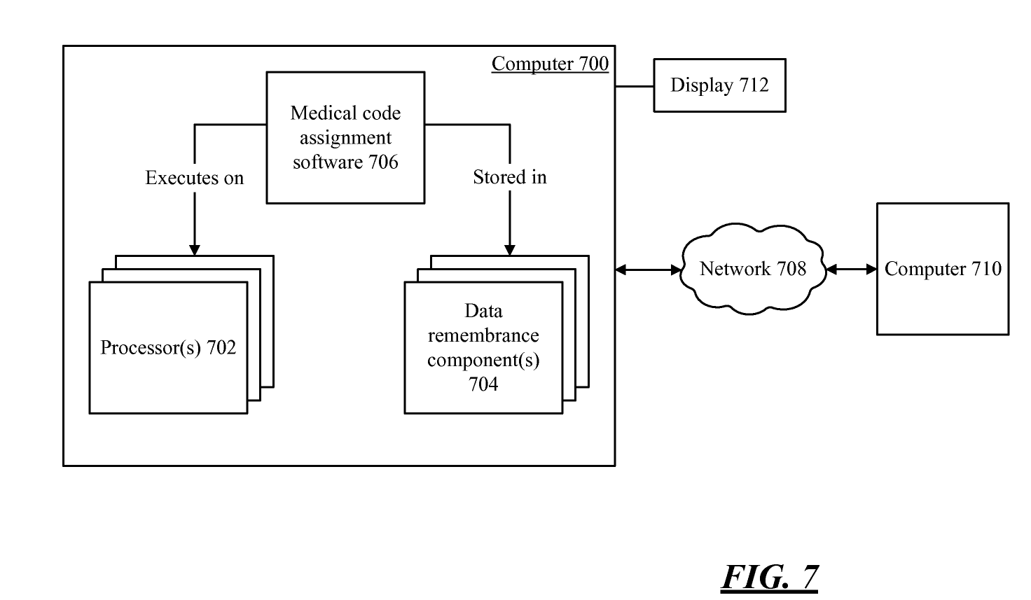

FIG. 7 shows an example environment in which aspects of the subject matter described herein may be deployed.

Computer 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is medical code assignment software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 700 may be communicatively connected to one or more other devices through network 708. Computer 710, which may be similar in structure to computer 700, is an example of a device that can be connected to computer 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to assign codes to medical data, wherein the executable instructions, when executed by a computer, cause the computer to perform acts comprising:
receiving input text that contains a description of a medical condition of a first person;
building a query from said input text;
comparing said query with a target medical vocabulary, the target medical vocabulary comprising a plurality of codes, each of the codes corresponding to a condition, each of the codes being associated with a textual description of the condition to which the code corresponds;
identifying those one or more codes whose associated textual description matches the query; and
assigning a first one of the identified codes to said input text.

2. The one or more computer-readable storage media of claim 1, wherein said query comprises a plurality of expressions that are connected by one or more AND operators, and wherein said comparing comprises:
determining, for one of the textual descriptions, that there is exactly one term in said one of the textual descriptions that corresponds to each of the expressions in the query; and
determining, for said one of the textual descriptions, that there are no terms in said one of the textual descriptions that do not correspond to an expression in the query.

3. The one or more computer-readable storage media of claim 1, wherein said query comprises a plurality of expressions that are connected by one or more AND operators, and wherein said comparing comprises:
determining, for one of the textual descriptions, that there is at least one term in said one of the textual descriptions that corresponds to each of the expressions in the query.

4. The one or more computer-readable storage media of claim 1, wherein said building comprises:
removing punctuation and stop words from said input text.

5. The one or more computer-readable storage media of claim 1, wherein said building comprises:
identifying a stem of a word of said input text;
identifying a plurality of forms of said stem; and
including, in said query, an expression that comprises said plurality of forms joined by one or more Boolean OR operators.

6. The one or more computer-readable storage media of claim 1, wherein said acts further comprise:
replacing misspelled words in said input text with correctly spelled words.

7. The one or more computer-readable storage media of claim 1, wherein said acts further comprise:
identifying a synonym of a word of said input text; and wherein said building comprises:
including, in said query, an expression that comprises said word and said synonym joined by a Boolean OR operator.

8. The one or more computer-readable storage media of claim 1, wherein one of the textual descriptions comprises a plurality of words and an acronym for said plurality of words, and wherein said comparing comprises:
ignoring said acronym.

9. The one or more computer-readable storage media of claim 1, wherein said acts further comprise:
determining that one of said textual descriptions comprises: (a) a first word that contains only capital letters, and (b) a plurality of second words; and
determining that the number of letters in said first word is equal to the number of words in said plurality of second words.

10. The one or more computer-readable storage media of claim 1, wherein said acts comprise:
receiving, from a second person, verification that said first one of said codes corresponds to said input text.

11. A method of coding medical data, the method comprising:
using a processor to perform acts comprising:
receiving input text;
determining that said input text does not contain a code for a condition in a target vocabulary;
creating a query based on said input text;
comparing said query with textual descriptions of codes in said target vocabulary;
identifying a first one of said textual descriptions that corresponds to said query; and
assigning, to said input text, a first one of said codes that is associated with said first one of said textual descriptions.

12. The method of claim 11, wherein said comparing comprises:
assigning relevancy scores to each of said textual descriptions based on how well each of said textual descriptions matches said query; and wherein said identifying comprises:
identifying the highest of the relevancy scores.

13. The method of claim 12, wherein said relevancy scores are applied to matches that are identified using a Boolean query.

14. The method of claim 11, wherein said query comprises a plurality of expressions that are connected by one or more AND operators, and wherein said comparing comprises:
determining, for one of the textual descriptions, that there is exactly one term in said one of the textual descriptions that corresponds to each of the expressions in the query; and
determining, for said one of the textual descriptions, that there are no terms in said one of the textual descriptions that do not correspond to an expression in the query.

15. The method of claim 11, wherein said query comprises a plurality of expressions that are connected by one or more AND operators, and wherein said comparing comprises:
determining, for one of the textual descriptions, that there is at least one term in said one of the textual descriptions that corresponds to each of the expressions in the query.

16. The method of claim 11, wherein one of the textual descriptions comprises a plurality of words and an acronym for said plurality of words, and wherein said comparing comprises:
ignoring said acronym.

17. The method of claim 11, further comprising:
using a processor to perform acts comprising:
determining that one of said textual descriptions comprises: (a) a first word that contains only capital letters, and (b) a plurality of second words; and
determining that the number of letters in said first word is equal to the number of words in said plurality of second words.

18. A system for coding medical data, the system comprising:
a processor;
a data remembrance component;
a query builder that receives an input text, that removes punctuation and a pre-defined set of words from said input text, that replaces misspelled words in said input text with correctly spelled words, and that builds a query that comprises an expression for each word in said input text, a first one of the expressions comprising: (a) a word from said input text; (b) one or more other words that have the same stem as said word, and (c) one or more synonyms for said word; and
a query engine that compares said query with textual descriptions in a target medical vocabulary, each of said textual descriptions being associated with a code in said target medical vocabulary, said query engine determining which of said textual descriptions matches said query and assigning, to said input text, a code that is associated with a textual description in said target medical vocabulary that matches said query.

19. The system of claim 18, further comprising:
a filter that determines whether said input text contains a code for a condition defined in said target medical vocabulary.

20. The system of claim 18, wherein said query comprises said expressions joined by AND operators, and wherein said query engine determines, for each of said textual descriptions, whether there is a word in the textual description for each of the expressions in said query, and further determines, for each of said textual descriptions, that there are no words in the textual description that do not correspond to an expression in the query.
